(19) United States
(12) Patent Application Publication
(10) Pub. No.: US 2009/0144654 A1
(43) Pub. Date: Jun. 4, 2009

(54) METHODS AND APPARATUS FOR FACILITATING CONTENT CONSUMPTION

(76) Inventors: Robert Brouwer, Zurich (CH); Ahmed Abdulwahab, Berlin (DE)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/245,309

(22) Filed: Oct. 3, 2008

Related U.S. Application Data
(60) Provisional application No. 60/977,254, filed on Oct. 3, 2007.

(51) Int. Cl. G06F 3/048; G06F 3/01

(52) U.S. Cl. 715/802; 715/700

(57) ABSTRACT

Methods and apparatus for the online consumption of content. The use of a markup language to implement unique identifiers in content allows for the measurement and analysis of users' interaction with that content. Online reading aids such as visual masks and density indicators facilitate the users' interaction with that content.

### CROSS-REFERENCE TO RELATED APPLICATIONS

The present application claims the benefit of co-pending U.S. provisional application No. 60/977,254 filed on Oct. 3, 2007, the entire disclosure of which is incorporated by reference as if set forth in its entirety herein.

### FIELD OF THE INVENTION

The present invention relates to the field of knowledge management, and more particularly to methods and systems for facilitating sharing, studying and markup of digital content through the measurement of user and content interaction.

### BACKGROUND OF THE INVENTION

### Content Consumption Measuring

Current Learning Management Systems (LMS) or Learning Content Management systems (LCMS) deliver content synchronously or asynchronously either as files or “learning objects” to users in corporate, educational, and administrative environments. The LMS platforms deliver, track and manage training, while the LCMS are used for storing, controlling, versioning, and publishing such materials.

However, these systems do not provide detailed feedback on how content is consumed by a user. Current systems provide mostly high-level information to the document level and are not capable of providing specific user interaction information on a more granular level in specific sections of the content. Current systems can, for example, provide information such as user names, time of login file types, and the time the content file was requested. This data is limited and not sufficient to determine how, for example, users interacted within a text, in which sequence they read or interacted with sections or paragraphs, viewed other embedded content assets, or how often they revisited certain sections or paragraphs, etc.

Current systems do not provide such granular information as these systems are designed mainly for content delivery and content management. Accordingly, there is a need for methods and apparatus that determines how a user specifically interacted with content.

### Facilitated Content Consumption

With the introduction of improved electronic displays, users typically spend extended periods of time reading content presented on such a display. Other elements on the display may distract the user when reading. These elements could be advertising messages, animated messages of any kind, video clips, clip art, menus, or windows of an application. Some users use a cursor to stay focused on the text as they read or scroll the text so that their view remains centered as they continue reading.

Moreover, it is often difficult to convey the “density” of integrated information presented on an electronic display, i.e., the number of content assets that have been integrated with various sections of a digital document. These assets could be for example hyperlinks or assets such as documents or other files that are embedded in the document. Methods and apparatus for embedding such assets are disclosed, for example, in U.S. patent application Ser. No. 11/521,053, assigned to the owner of right of the instant application. Accordingly, there is also a need for methods and apparatus to help users remain focused as they read content presented on an electronic display, and methods and apparatus helping users to identify the density of content per section.

### SUMMARY OF THE INVENTION

### Content Consumption Monitoring

Certain embodiments of the invention provide methods and apparatus for measuring how users access and interact with content. An exemplary embodiment includes at least three elements:
1. Evaluating a user's position within content displayed on an electronic display; and
2. A Global Unique Identifier (GUID) or other means inside the content or in an associated markup language structure at the topic, paragraph or a more granular level for identifying the content associated with a user activity; and
3. Logging interactions in relation with the content.

Embodiments of the present invention may further include identifying and rating the level of user interaction with the content.

In one aspect, embodiments of the present invention provide a method for measuring digital content interaction. The method includes presenting a content asset on an electronic display, the content asset having a plurality of identifiers, each identifier associated with a section of that content asset. The identifier may be globally unique. A time, at least one identifier, and at least one event associated with a user's interaction with the content asset is recorded. The recorded information is analyzed to characterize the user's interaction with the content asset. The process is repeatedly iterated.

In one embodiment, the content asset includes readable content interspersed with markup language assigning at least one identifier to a portion of the content asset. In one embodiment, analyzing to characterize the interaction includes computing an average number of characters reviewed per unit time. In another embodiment, analyzing to characterize the interaction comprises assigning a label to the user's interaction based on the frequency of the user's interaction with the document. The recorded event may be weighted, where the assigned weight is a function of the type of event recorded. The recorded data may be associated with a user profile.

### Facilitated Content Consumption

Certain embodiments of the present invention provide a digital reading aid that facilitates the reading of content on an electronic display. When activated, the reading aid obscures everything else on the display aside from a specified section using, in certain embodiments, an opaque or semi-transparent mask that only reveals one section of text or paragraph at a time. These obscured regions or objects can include, e.g., menus, notes, or open files. By using the scroll bar, mouse or other controls (e.g., the space bar) a user can skip forward or backward to the next section for review. A user can deactivate the reading aid at any time.

In one aspect, embodiments of the present invention provide a method for facilitating digital content interaction. A content asset is presented on an electronic display, the content asset having a plurality of sections. The entirety of the electronic display except for the section currently under review by an end user is at least partially obscured. A different region of the display is at least partially obscured in response to the end user's review of a section differing from the section currently under review by the end user. The translucency of the obscured region may be adjusted.

In one embodiment, obscured user interface elements may be operated. In another embodiment, certain items may be designated exempt from obscuring and are therefore not obscured. Obscuring a different region may include moving the content asset relative to an obscuring overlay, or it may include moving an obscuring overlay relative to the content asset.

Other embodiments of the present invention provide an indicator that shows through different levels of shading the density of content integration of a digital document or content asset in various sections, such as paragraphs. The indicator shows the quantity of digital assets that are attached or integrated in a particular section of a content asset. This can, for example, be displayed or visualized through the gradient, the intensity of shading, etc. The visual indicator can be placed in any position on the user interface, e.g., in its own window.

In one aspect, embodiments of the present invention provide a method for facilitating digital content interaction. A content asset is presented on an electronic display, the content asset having at least one section, each section comprising at least one association with a further item of content. A density indicator is presented in proximity to at least one of the sections, the density indicator reflecting the number of associations for that particular section, wherein the density indicator reflects the number of associations using at least one of a number, a color, a shading, and a shape.

In one embodiment, each further item of content is a file or a link. In another embodiment, the density indicator further indicates the type of the further item of content using at least one of a number, a color, a shading, and a shape. The density indicator may indicate the number of associations on a line-by-line basis within the section.

The foregoing and other features and advantages of the present invention will be made more apparent from the description, drawings, and claims that follow.

### BRIEF DESCRIPTION OF DRAWINGS

The advantages of the invention may be better understood by referring to the following drawings taken in conjunction with the accompanying description in which:

FIG. 1 shows an example of content presented on an electronic display;

FIG. 2 presents an example of the structure of content presented on an electronic display;

FIG. 3 illustrates the application of tags, e.g., such as a Global Unique Identifier (GUID), for identifying and distinguishing among each section in the content, e.g., chapters, topics, paragraphs, sub-paragraphs, topics, sentences, words, pictures, etc.;

FIG. 4 presents an exemplary apparatus for implementing an embodiment of the present invention

FIG. 5 presents a flowchart of a method for capturing information on a user's interaction with content in accord with the present invention;

FIG. 6 shows a flowchart of another method for capturing information on a user's interaction with content in accord with the present invention;

FIG. 7 shows an example of a text presented on an electronic display;

FIG. 8 shows a text presented on an electronic display organized in sections, e.g., paragraphs, topics or objects, etc.;

FIG. 9 presents one embodiment of a reading aid for an electronic display in accord with the present invention;

FIGS. 10a-10c depict the digital reading aid of FIG. 9 in typical operation;

FIGS. 11a-11c show the different opacity settings of the reading aid in various embodiments;

FIG. 12 shows an example of a text presented on an electronic display;

FIG. 13 shows a text presented on an electronic display organized in sections, e.g., paragraphs, topics or objects, etc.;

FIGS. 14a and 14b illustrate a content asset having multiple assets and links in two consecutive sections corresponding to two paragraphs in the content file;

FIG. 15 presents an example of the aforementioned density indicator in accord with the present invention;

FIG. 16 shows a detailed view of the aforementioned density indicator in operation;

FIGS. 17a-17e illustrate different embodiments of the present invention using intensity and gradient to show the density of content per section; and

FIGS. 18a-c illustrate another embodiment of a density indicator in accord with the present invention.

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

### Content Consumption Monitoring

Certain embodiments of the invention describe a method for determining the level of user interaction with digital content presented on an electronic display. The level of user interaction with the content can be used to determine, for example, the effectiveness of the learning process and the content itself by comparing one user's interaction patterns with those of other users.

The captured user and interaction data that is part and the result of the present invention can, in combination with other information as specific user data, be processed and displayed, for example, using a business intelligence system. This allows recognition of interaction, usage, and reading patterns of users with respect to the content. Embodiments of the present invention facilitate the collection of interaction data that can be retrieved and interpreted by such systems.

In some embodiments, an XML-based markup language (IML) is used to tag content. IML restructures content at the paragraph level (or even the line level or the object level, depending on the embodiment) and provides a unique GUID for, e.g., each paragraph, note created, text, etc. Copied content receives a new GUID so that it remains uniquely identifiable. In one embodiment, the word <chapter id> is used to define the GUID followed by CHAP for Chapter, PARA for Paragraph, etc. Again, depending on the embodiment this structure could be applied all the way down to the level of individual characters in the text, individual graphics, charts, etc. In this embodiment, the CHAP is followed by an ID number that gives the chapter a unique global identity.

Breaking text into paragraphs, sentences, or characters and associating these elements with a unique GUID makes it possible to track the user's interaction with the content. As a result it is possible to track each user's interaction with the content and measure the sequence and interaction intensity, which can then be analyzed with a business intelligence tool or similar data analysis tool.

Sample Code:

<?xml version=“1.0” encoding=“iso-8859-1”?>
<chapter id=“CHAP_d7518e10-56c9-42a0-a2a2-9838e7a4eb03” num=“1”
xmlns:fn=“http://www.w3.org/2005/xpath-functions” spage=“1” epage=“22”>
<paragraph id=“PARA_a6baa399-c83d-4c6f-a775-c8a044b44850” num=“1”
type=“normal”>
<text style_class=“title”><![CDATA[example content example content example content
example content example content example content example content.............]]></text>
</paragraph>
paragraph id=“PARA_a9dc3b72-e90f-4269-9890-c1d78f511a7f” num=“2”
type=“normal”>
<text style_class=“text”><![CDATA[ <b>example Name of Author</b> ]]></text>
<text style_class=“text”><![CDATA[ <i>Example content </i> ]]></text>
<text style_class=“text”><![CDATA[ <i> Example content </i> ]]></text>
</paragraph>
<paragraph id=“PARA_79450e7a-907d-41f7-92ac-84432da5162f” num=“3”
type=“normal”>
<text style_class=“heading1”><![CDATA[ Abstract ]]></text>
</paragraph>
<paragraph id=“PARA_2e138baa-8c4f-4073-88d3-df4eb76cb11e” num=“4”
type=“normal”>
<text style_class=“text”><![CDATA[example content example content example content
example content example content example content example content example content
example content example content example content example content.............]]></text>
<pagebreak num=“1” seq=“1”/>
<text style_class=“text”><![CDATA[example content example content example content
example content example content example content example content example content
example content example content example content example content example content
example content.............]]></text>
</chapter>

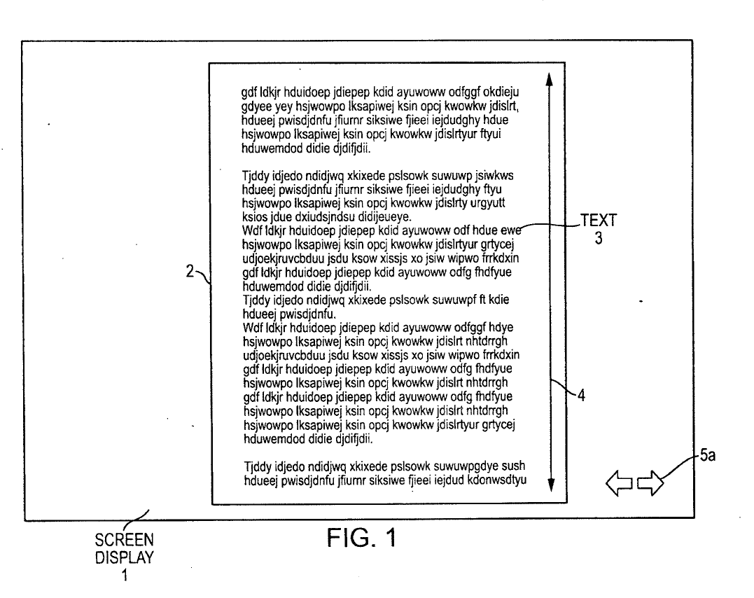

FIG. 1 shows an example of digital content presented on an electronic display 1 by a software application that displays content 3 in a view 2. The content can be composed of different elements such as a page, chapters, a selection of texts, paragraphs, diagrams, charts or other digital content formats (e.g., Acrobat files). The content may be navigated using a scroll-bar 4, navigation arrows 5, or other means. The content visible to the viewer at any point in time is limited by the size of the display and its resolution. Any interactions such as scrolling, skipping via visual indicators such as graphical arrows shown on the screen, or clicking in the content which changes the display of the content on the screen is reflected in the display in view 2.

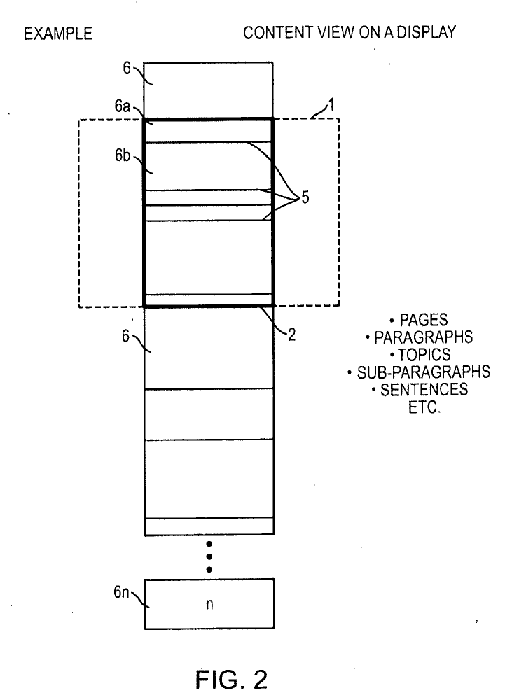

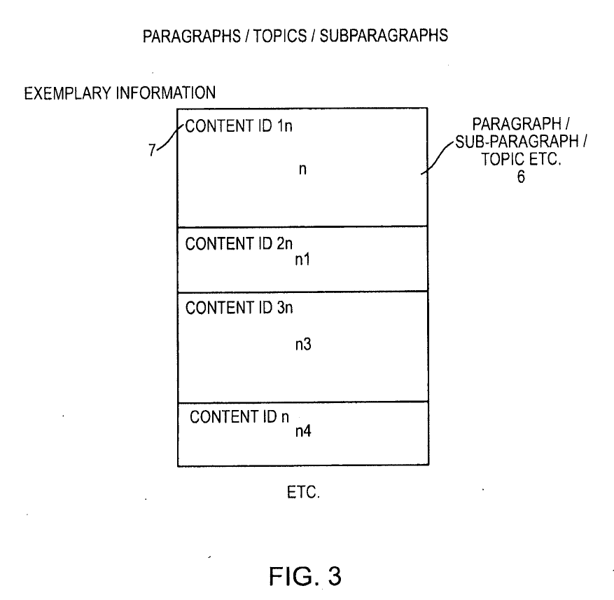

The content displayed can be, for example, organized into pages, chapters, sub-chapters, topics, paragraphs, sub-paragraphs, sentences, words, or characters. In the example of FIG. 2, the content is shown in an endless scrolling format and consists of several content items 6a-6n. The content items visible are for example 6a and 6b and a few other paragraphs as the size of the display screen 1 limits the view. Each content item 6 is separate from the other content items and is identified by a unique identifier ID 7 as shown in FIG. 3. The content items may or may not be visually be separated by a line or marker line 5. As shown in FIG. 3, the identifier 7 uniquely identifies each of the content items 6 within the overall document, such as a chapter, document or book consisting of many content items 6 each having separate identifiers 7.

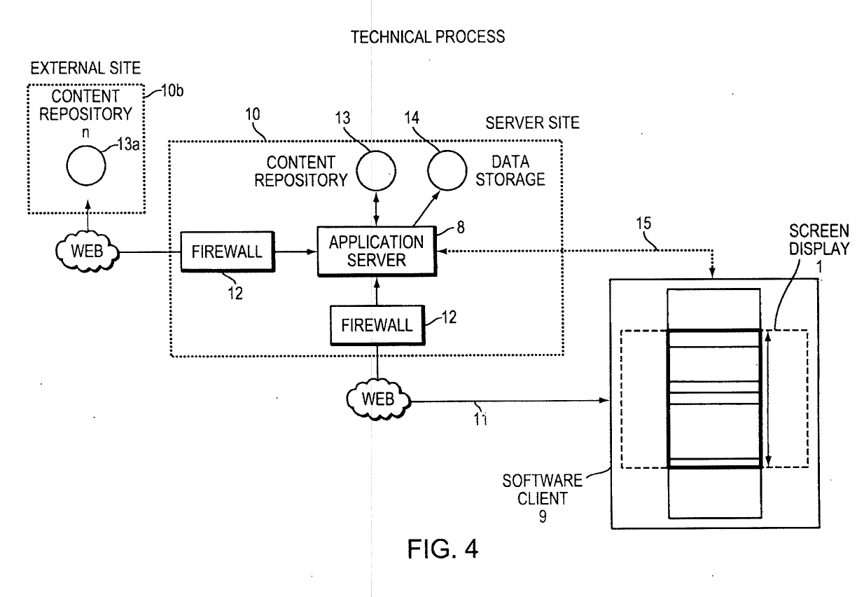

FIG. 4 shows one example of a computer architecture suited for the implementation of one embodiment of the present invention. An application server 8 serves the content stored in at least one content repository 13 and appears as a system 10 to the client application 9. The software platform consists of at least one application server 8 and software clients 9 that can access the server 8 remotely via telecommunications links 11 or 15. A content repository 13a can also reside remotely on a separate system 10b. Other optional components such as firewalls 12 manage access to the application server 8. Communication between client 9 and server 8 can be via the Web 11 or an intranet 15. Content is requested by the software client 9 and is then retrieved by the application server 8 from a content repository 13, 13a and is delivered to the client.

As the content is displayed at the client 9, information on the user's interactions with the content is captured, synchronously or asynchronously sent back to the server 8, and then stored in storage 14 or at another location. The stored information can then be retrieved separately by other software such as a business intelligence or spreadsheet application for calculating and displaying specific user and content interaction information.

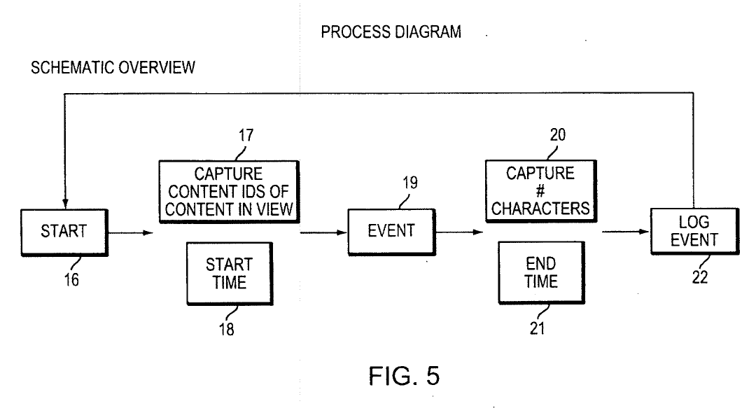

FIG. 5 is a flowchart presenting a simplified method for capturing interaction data. The process starts (Step 16) by making a record of all the content IDs of all the content that is in view on the display (Step 17). The content in view may include the entirety of content visible anywhere on the display including, for example, multiple views, floating notes or other visible content. Next the time is captured (Step 18). If no content ID 7 is associated with the presented content, then a new content ID may be being generated. The capture of information is continuous, and times are recorded as events occur.

The method waits for an event to occur. If an event occurs (Step 19), such as an event that alters the information displayed on screen through means of navigation, e.g., scrolling, page clicks, etc. then the number of characters of each content item in view are captured along with the content IDs, time and other information (Steps 17, 18, 20, and 21). This information is then logged (Step 22) in a database 14. This process is then repeated with a frequency that can vary according to the level of user activity in certain embodiments. As mentioned, the process repeats continuously, e.g., every second.

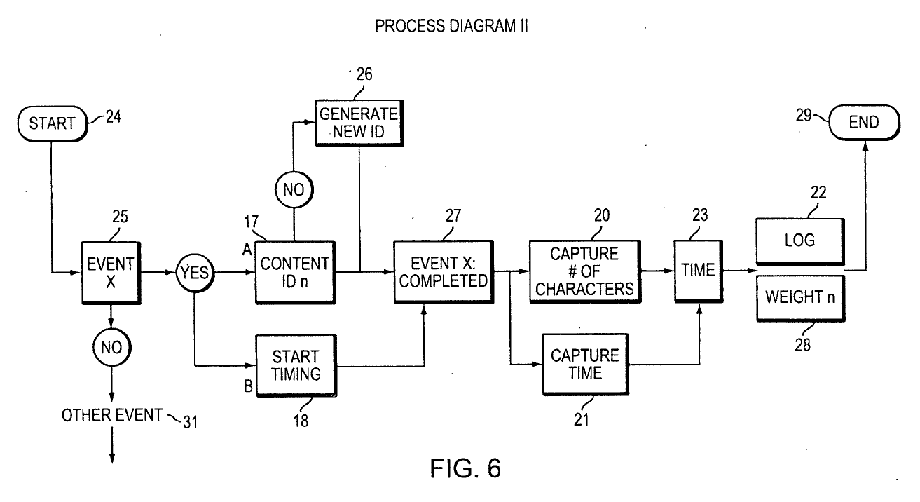

With reference to FIG. 6, if the event (Step 25) is an interaction with a particular item of content, other than a navigation event as described in the preceding paragraph, such as highlighting, copying and pasting text or a picture, or the activation of a hyperlink using a cursor or mouse, then these events may receive additional weight (Step 28) for that content id. Weights may vary from activity to activity. For example, highlighting a content section may carry a different weight than copying content to create a note. If, for example, four paragraphs are in view and a user highlights a portion of one paragraph, then the paragraph ID of that particular content item is captured (Step 17A), a note is made of the highlighting event, an ID of the content highlighted is generated (Step 26), and the time is again captured (Step 21). An additional weight is assigned to reflect the difference between the highlighting activity of that particular item compared to the other content items currently in view that have not been the subject of interaction. The information is logged (Step 22), e.g., in a database. The process repeats itself for all other events as well as navigation events as described in the preceding paragraph. Embodiments of the present invention may process navigation events and non-navigation events in parallel.

In one embodiment, the level of interaction is measured using the total number of characters or words reviewed in a particular time period. This yields a value in characters or words per unit of time. This information can then be used to determine the user's level of interaction with the content. The interaction value could, for example, range from skimming, low interaction, normal interaction, high interaction, to intense interaction with the content. For example, assume the system measures for a content item that contains, for example, 686 characters, a time of 22 seconds until the occurrence of an event or captured the time. This yields a value of 30.2 characters per second, i.e., a normal intensity, meaning that the user spent an average amount of time reviewing that particular item of content. Each time a user performs an event associated with one or more content items 7, the interaction value may be determined and an additional weight 28 imposed to reflect the heightened interaction value of that content.

For example, when a user logs into the client, the time is logged. When the user logs off or the system is inactive (e.g., no mouse movement is detected) these events are also logged. Inactivity is also logged and, e.g., subtracted from the time the user has spent online, within a paragraph, note, etc.

When a user, for example, uses the scroll arrows or scrolls using the mouse faster than a certain speed, the starting point for this interaction is determined from the location of the last event (e.g., click on note) that the user performed within the content. The stop point is also noted and the difference between the starting and ending point is then classified as, for example, “light” or “no interaction.” Whenever notes are clicked or opened, communications are started within the content (i.e., text, audio, or video), notes are created and attached, notes are shared and placed within content, etc., all of these events are stored by the system along with the appropriate GUID from the content. Moreover, the more notes created by users and attached to specific locations in the content, then the higher the weight assigned to another user's interactions at those same locations in the content, relative to other locations lacking notes.

Whenever a user opens or selects a content asset, a file, a document, a note, etc., the GUID (or the filename for external files) and the time may be logged and stored with the user's profile. The more notes opened in a specific location in the content, the higher the weight assigned to the user's interactions. Content assets that do not have a specific GUID receive the GUID via a secondary content asset, which is attached or linked to a specific section in the source content. Such secondary content, which could be a note, act as a linkage between the source content assets and the content file that it is attached or linked to. It contains the information needed including the GUID and may carry other information such as metadata or other text that the file itself does not necessarily carry.

When a user scrolls within a document or any presented content, the GUID is logged and the time is stored and a category is applied. The system records all time-based events and associates these with, e.g., the GUIDs of the document, paragraph, and notes and applies to each GUID a category. The result is a user profile for each topic, paragraph, sub-paragraph, section, line, or word of content that has a GUID. In addition, it also yields a content profile that shows the level of interactions such as content attachments per section over time, the content visits over time, etc. This helps to determine the level of interaction and may help to determine how to improve the content.

Each interaction value is associated with a certain level of activity. If a user spends significant time within a paragraph and clicks on numerous notes or creates a certain number of notes it may count as “active learning.” If the user does not create a note and simply scrolls slowly through a section it could count as “light interaction” or “medium interaction.”

The reason for logging and then classifying events is to create a record of learning or a profile of where a user spends the most time reading, and where a user spends time skimming text. Specific content may also be analyzed and its level of interaction can be determined by the type of users over time. One goal is to determine the speeds various users require to comprehend a text and accordingly allow for the restructuring or modification of the content to provide the best possible content for certain users. Another goal is to analyze interest in certain content by specific groups of users, which makes it possible to serve the right mix of different content assets that are more likely be interesting to that group. By logging the users' activities, a unique learning profile is created that can be analyzed with software such as business intelligence tools.

### Facilitated Content Consumption

Other aspects of the invention facilitate the reading of content online. One aspect of the invention provides a reading aid that when activated, hides all interface elements such as menus, notes, open files, etc., using an opaque or semi-transparent mask that only reveals one section of text such as a paragraph at a time. By using the scroll-bar, mouse or other controls (e.g., space bar) the user can skip forward or backward to the next section or paragraph. This allows users to focus on the current paragraph while hiding from view unnecessary information such as notes, allowing the user to maintain concentration while reading. The user can deactivate the reading aid at any time either by clicking on the masked area or via other means.

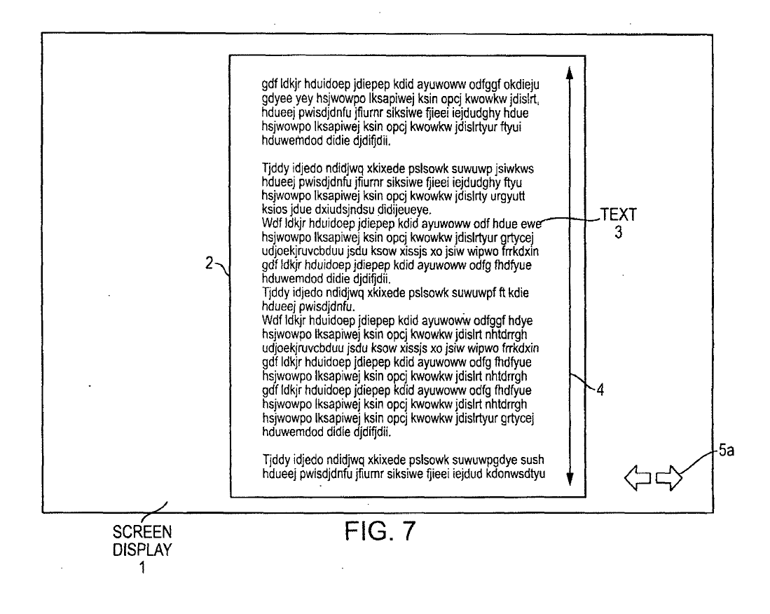

As shown in FIG. 7, content 3 including text and graphical elements may be presented on an electronic display 1 in a window 2. The window 2 may have a scrollbar 4 or other page control elements 5a either visible or non-visible to control the content viewed.

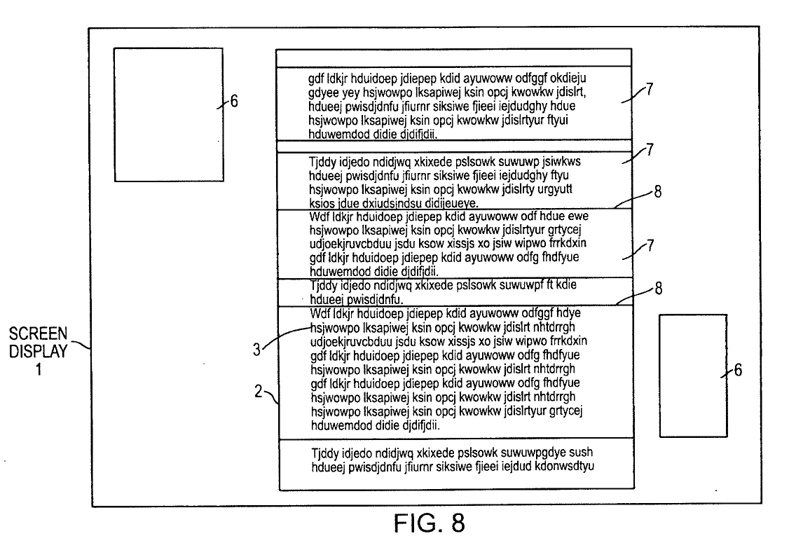

As shown in FIG. 8, an exemplary text 3 includes several paragraphs 7 that may or may not be visually separated with a graphical element 8, which is in this example a solid line for visually separating the paragraphs.

Additional objects 6 may also be presented on the display 1. These objects can include, for example, menus or windows of other applications or the user interface for the application displaying the text 3. The objects 6 could, for example, also be other content files or floating menu or control pallets.

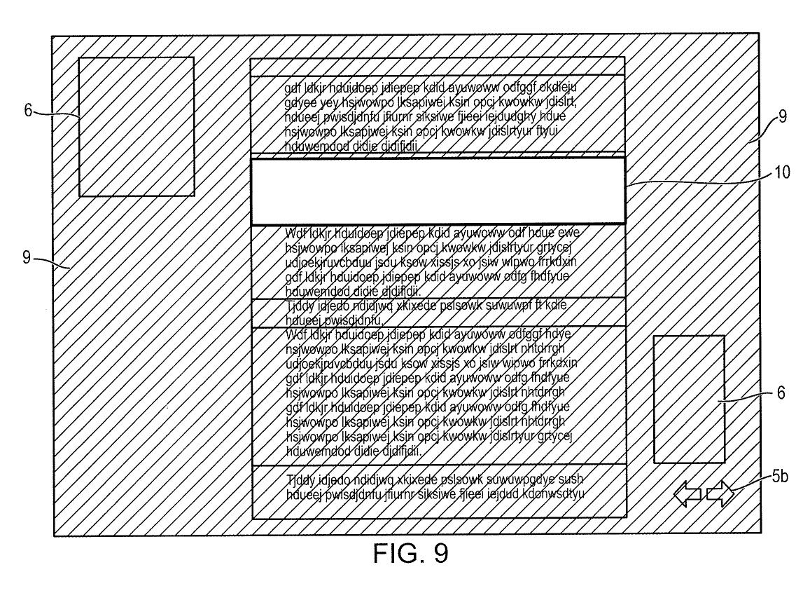

FIG. 9 shows one embodiment of the reading aid in active mode. The reading aid is a opaque or semi-translucent mask that obscures everything except the content currently in view 10; in this case a paragraph 7. All other paragraphs or objects 6 are hidden from view by the reading aid 9, which automatically adjusts the size of the mask 10 (or, alternately, the side of the whitespace) to the content that is currently being reviewed.

Although the reading aid operates to obscure other items, in certain embodiments the user may configure the reading aid to allow for the operation of those objects 6 that are obscured but still visible. The user can activate or deactivate the mask via a menu selection.

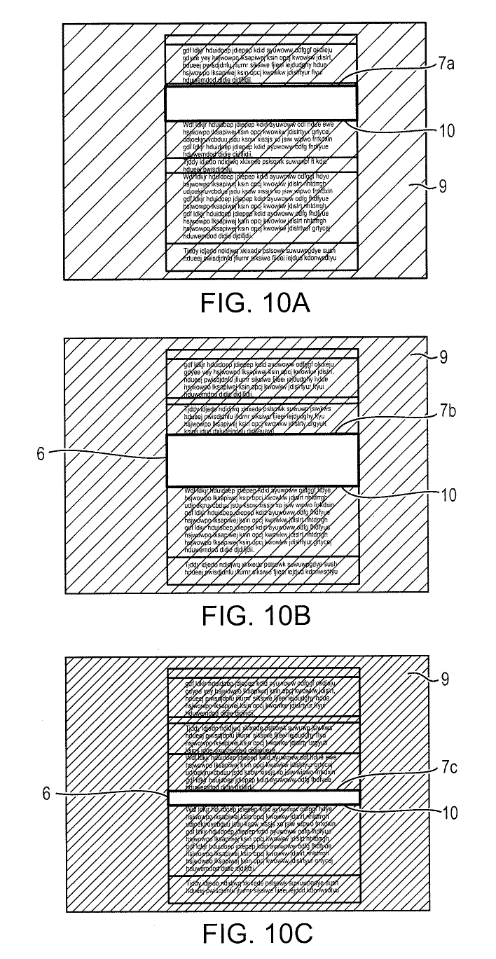

As shown in FIGS. 10a-10c, the user may control the movement of the reading aid via the regular page controls on the computer keyboard, the mouse, track pad, through input devices, visual control buttons or through other means. When moving the reading aid 6, the reading aid moves to the next or previous content section such as paragraph 7a-c as shown in FIG. 4a, 4b and 4c. In each case the size of the mask opening 10 adjusts to its size of the content 7—in this case a paragraph.

In another embodiment, the text page with the content moves downward or upward while the mask remains stationary and adjusts its size to the content section. In this embodiment, the mask would be more or less centered on the display device. In yet another embodiment, certain content objects are designated as exempt from the mask and made visible while other objects such as windows with other content assets remain hidden behind the mask.

In still another embodiment, the mask itself would move. If, for example, the mask is moved downward such that it reaches the bottom of the display, in this case the last paragraph, it could jump back to the top and continue to move downward unless the user stops the movement process. In this case the mask also adjusts to the size of the content item.

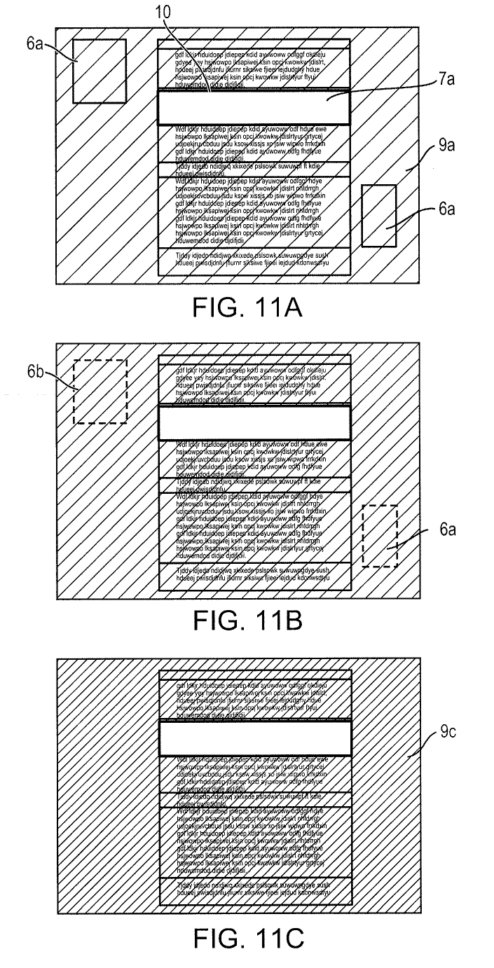

As shown in FIGS. 11a-11c, it is also possible to adjust the translucency of the mask 9a-9c. This allows users to control the amount of secondary information visible from objects 6 on the display 2. These figures illustrate how, for example, objects such as control windows or other content assets can be hidden from view by adjusting the opacity of the mask.

Another aspect of the invention concerns a user interface element that displays the density of content such as linked files and other content assets that are attached, linked or embedded within a parent content asset or file. Using graphic elements such as shading, as discussed below, a user can be shown how much content has been linked to a particular section of a content asset. In certain embodiments a user can filter or further analyze, for example, the number and type of particular content types that have been attached at a particular location in the content asset. This filtering could, e.g., display notes, display document types, display communications (i.e., text, audio, or video), display assets added at certain point in time, display assets that were initiated at a particular point in the content, etc.

Traditional methods do not allow users to understand the density of linked content in a particular content asset. Embodiments of the current invention permit users to have a ready overview not only of the number but also the types of content that are linked in the parent content item. These linked content assets can be any type of content, such as a PDF or Word file, as well as images, media files, etc., and are attached or linked to a specific section in the source content. Such linked content acts as a linkage between the source content assets and the content file that it is attached or linked to. It contains the information needed including the GUID and may carry other information such as metadata or other text that the file itself does not necessarily carry.

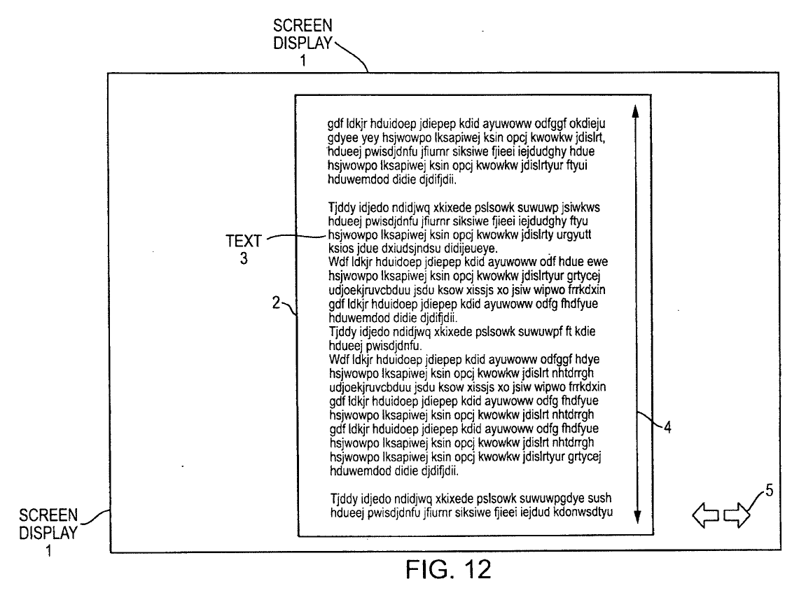

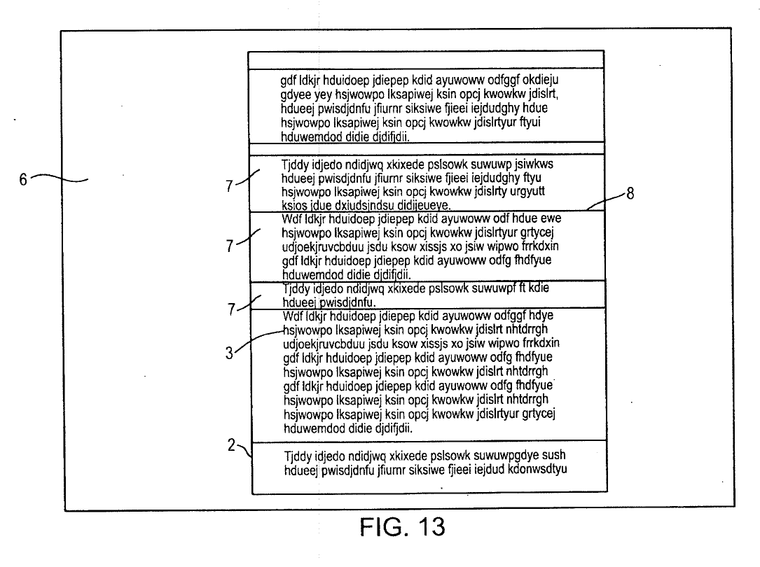

FIG. 12 presents an example of a content asset 3 presented on an electronic display 2. When integrating digital assets into the content or reviewing the assets already integrated into the content, a user may want a convenient way to recognize the number of content assets as well as the type of content that are integrated in various sections 7 of the parent content 2. As shown in FIG. 12, the user can scroll and navigate through the content 3 using means such as a scrollbar 4, page controls 5, etc. FIG. 13 shows how the content 3 has one or more pages each composed of paragraphs 7; these paragraphs may or may not be visually separated.

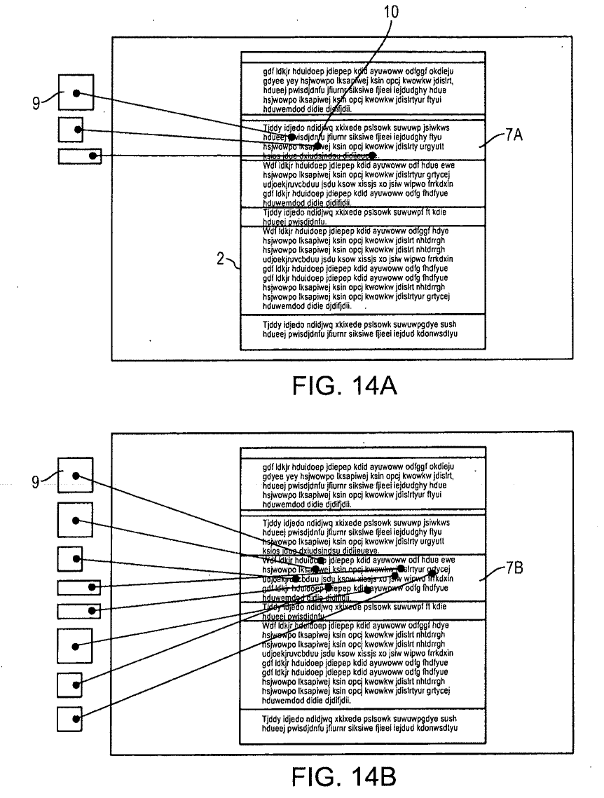

FIGS. 14a and 14b show an example of a content asset 2 having two different sections, here paragraphs 7a and 7b, that have linked, attached, or embedded different content assets 9. As mentioned, these content assets 9 can be any files, links, references, etc. In this example, paragraph 7a contains three content assets, while paragraph 7b contains nine content assets.

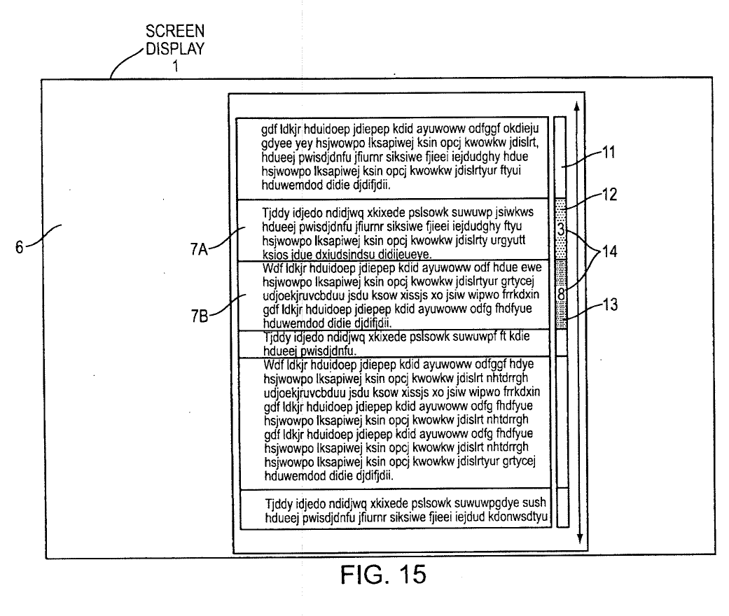

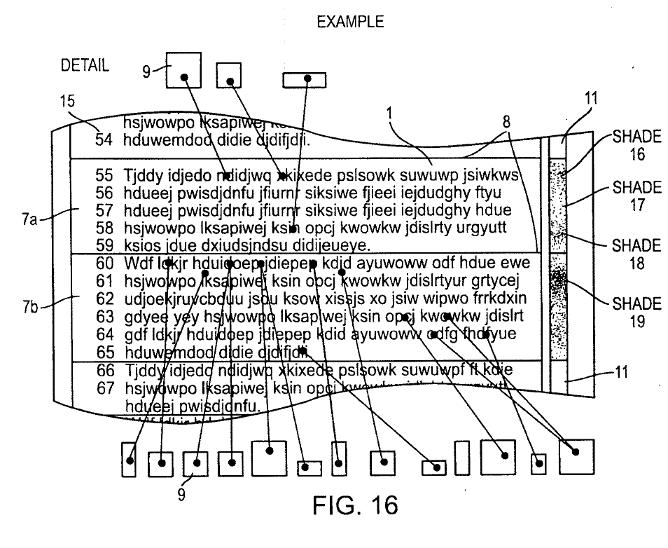

As illustrated in FIG. 15, in one embodiment a number 14 next to the content section 7A, 7B is used to convey to users who are interacting with the content the number of assets linked, attached or embedded in the content section under their review. The same information may also be conveyed through shading intensity 11, 12, and 13. The shading of the indicator 11 beside content section 7A shows a lower intensity 12 because of the lower number of assets attached as the shading of content section 7B, which has a higher intensity 13 and has a higher number of content assets attached. Other content sections with no embedded content may not be shaded at all. As FIG. 16 depicts, both shading and numbers can be combined in certain embodiments of the density indicator. As illustrated in FIG. 16, in another embodiment the number of assets linked, attached or embedded in the content section under their review is conveyed through shading gradients 16-19.

In another embodiment, reciprocal shading is used, such that the strongest shading intensity, which could be opaque, indicates the least number of content attachments per section. In still another embodiment, colors are used to indicate different content assets.

FIG. 16 also illustrates that the indicator 11 may have different levels of shading on a per-line basis to indicate the number of content assets attached to a sentence or line 15. For example, shade 16 is darker than shade 18 because line 55 carries more assets than line 58. As line 57 has no content assets, shading 17 is completely unshaded. In this example, shading 19 is associated with the line containing the most content assets and as a result has the highest shading intensity. The range of shading used in the density indicator can be specific to the concentration of assets in particular content file or document, or it can reflect an absolute scale for asset concentration, allowing the comparison of concentration across multiple documents.

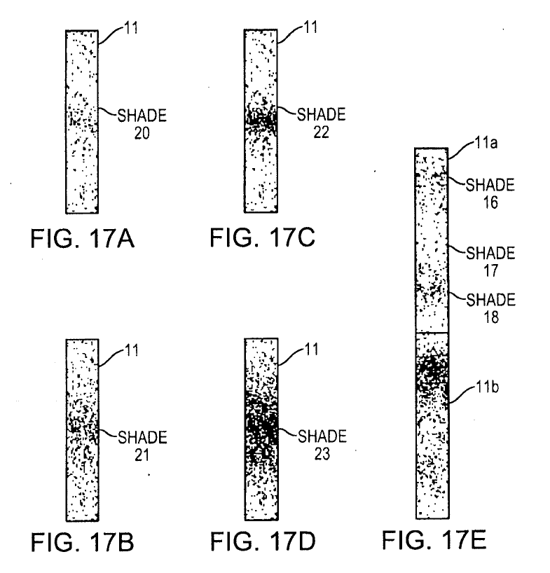

FIGS. 17a-17e show in greater detail an embodiment of the density indicator utilizing shading intensities. FIG. 17a shows an indicator associated with a medium number of content assets, while FIG. 17c shows a much higher number of assets in that same section with a medium amount in the sentences immediately below and above that line. The shading level may be determined, for example, with respect to a maximum shading which can be defined as the most assets embedded in a particular section; the shading for other levels of asset embedding are adjusted accordingly. The shading of the indicator can also be determined against an absolute scale, so that a certain intensity relates to a certain level of content assets embedded in a particular section, which then allows for the comparison of levels of embedded assets across a number of different documents using the same scale.

FIG. 17b indicates that compared to FIG. 17a, there are many more files in the sentences below and above the line, the line itself having a medium amount of content assets. The shading 23 in FIG. 17d shows a similar distribution with even more content files on the line itself and fewer content files on the lines above and below that line. The shading 21 in FIG. 17b shows an almost evenly distributed level of content assets, with the most assets in the center of a content section and asset concentrations which decrease linearly above and below until the top and bottom, where there are no assets. In another embodiment, shown in FIG. 17e, a single indicator may have several sections 11a, 11b, with each section relating to a specific content section.

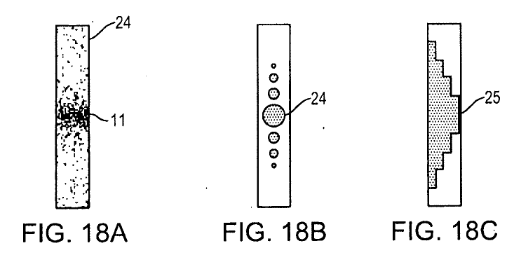

FIGS. 18a-18c show other embodiments of a density indicator using geometric shapes to convey the density of content assets linked, attached, or embedded in a content asset. For example, FIG. 18b uses circles to indicate the information density while in FIG. 18c the same information is conveyed using rectangles or squares.

In still another embodiment, color is used to convey information concerning the type of content assets, for example, the color red concerns media files, while yellow concerns comments. Again, shading may be used to display, e.g., the number of documents. Various further embodiments combine one or more of color, shape, and shading in a density indicator.

It will therefore be seen that the foregoing represents a highly advantageous approach for presenting content online, including techniques for measuring interaction with online content. The terms and expressions employed herein are used as terms of description and not of limitation and there is no intention, in the use of such terms and expressions, of excluding any equivalents of the features shown and described or portions thereof, but it is recognized that various modifications are possible within the scope of the invention claimed.

What is claimed is:

1. A method for measuring digital content interaction, the method comprising:
presenting a content asset on an electronic display, the content asset having a plurality of identifiers, each identifier associated with a section of that content asset;
recording a time, at least one identifier, and at least one event associated with a user's interaction with the content asset; and
analyzing the recorded information to characterize the user's interaction with the content asset.

2. The method of claim 1 further comprising repeatedly iterating the steps of method 1.

3. The method of claim 1 wherein analyzing to characterize the interaction comprises computing an average number of characters reviewed per unit time.

4. The method of claim 1 wherein the content asset comprises readable content interspersed with markup language assigning at least one identifier to a portion of the content asset.

5. The method of claim 4 wherein each identifier is globally unique.

6. The method of claim 1 wherein analyzing to characterize the interaction comprises assigning a label to the user's interaction based on the frequency of the user's interaction with the document.

7. The method of claim 1 further comprising assigning a weight to the recorded event.

8. The method of claim 7 wherein the assigned weight is a function of the type of event recorded.

9. The method of claim 1 wherein the recorded data is associated with at least one of a user profile and a content profile.

10. A method for facilitating digital content interaction, the method comprising:
presenting a content asset on an electronic display, the content asset having a plurality of sections;
at least partially obscuring the entirety of the electronic display except for the section currently under review by an end user; and
at least partially obscuring a different region of the display in response to the end user's review of a section differing from the section currently under review by the end user.

11. The method of claim 10 further comprising allowing the operation of an obscured user interface element.

12. The method of claim 10 further comprising not obscuring certain items designated as exempt from obscuring.

13. The method of claim 10 wherein obscuring a different region comprises moving the content asset relative to an obscuring overlay.

14. The method of claim 10 wherein obscuring a different region comprises moving an obscuring overlay relative to the content asset.

15. The method of claim 10 further comprising adjusting the translucency of the obscured region.

16. A method for facilitating digital content interaction, the method comprising:
presenting a content asset on an electronic display, the content asset having at least one section, each section comprising at least one association with a further item of content;
presenting a density indicator in proximity to at least one of the sections, said density indicator reflecting the number of associations for that particular section,
wherein the density indicator reflects the number of associations using at least one of a number, a color, a shading, and a shape.

17. The method of claim 16 wherein each further item of content is at least one of a content asset, file and link.

18. The method of claim 16 wherein the density indicator further indicates the type of the further item of content using at least one of a number, a color, a shading, and a shape.

19. The method of claim 16 wherein the density indicator further indicates the number of associations on a line-by-line basis within the section.

20. The method of claim 16 wherein the maximum value of the density indicator is calibrated to the content asset.

21. The method of claim 16 wherein the maximum value of the density indicator is calibrated against a scale that is independent of the content asset.
